(19) United States
(12) Patent Application Publication
(10) Pub. No.: US 2009/0293907 A1
(43) Pub. Date: Dec. 3, 2009

(54) METHOD OF SUBSTRATE POLYMER REMOVAL

(76) Inventors: Nancy Fung, Livermore, CA (US); Siyi Li, Fremont, CA (US); Ying Rui, Santa Clara, CA (US); Walter R. Merry, Sunnyvale, CA (US); Anchel Sheyner, San Francisco, CA (US); Kathryn Keswick, San Jose, CA (US); Shing-Li Sung, Campbell, CA (US); Mang-Mang Ling, Sunnyvale, CA (US); Chia-Ling Kao, Mountain View, CA (US); Wei-Te Wu, Cupertino, CA (US); Kang-Lie Chiang, San Jose, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/246,137

(22) Filed: Oct. 6, 2008

Related U.S. Application Data
(60) Provisional application No. 61/056,786, filed on May 28, 2008.

(51) Int. Cl. B08B 6/00

(52) U.S. Cl. 134/1.2

(57) ABSTRACT

Methods for cleaning a substrate are provided. In one embodiment, the method includes depositing a polymer on a substrate. A cleaning gas is provided to clean a frontside, a bevel edge, and a backside of the substrate. The cleaning gas may include various reactive chemicals such as H₂ and N₂ in one embodiment. In another embodiment, the cleaning gas may include H₂ and H₂O. Plasma is initiated from the cleaning gas and used to remove polymer that formed on a bevel edge, backside, or frontside of the substrate during semiconductor processing.

### CROSS REFERENCE TO RELATED APPLICATIONS

This application claims priority to commonly assigned U.S. provisional patent application Ser. No. 61/056,786 filed on May 28, 2008, entitled “METHOD OF SUBSTRATE BACKSIDE POLYMER REMOVAL”.

### BACKGROUND OF THE INVENTION

1. Field of the Invention

Embodiments of the present invention generally relate to semiconductor processing systems and methods. More specifically, embodiments of the invention relate to semiconductor processing methods utilized to remove polymers from a backside or frontside of a substrate without film damage during semiconductor fabrication.

2. Description of the Related Art

Integrated circuits have evolved into complex devices that can include millions of components (e.g., transistors, capacitors and resistors) on a single chip. The evolution of chip designs continually requires faster circuitry and greater circuit density. The demands for greater circuit density necessitate a reduction in the dimensions of the integrated circuit components.

As the dimensions of the integrated circuit components are reduced (e.g. to sub-micron dimensions), the importance of reducing presence of contaminant has increased since such contaminant may lead to the formation of defects during the semiconductor fabrication process. For example, in an etching process, by-products, e.g., polymers that may be generated during the etching process, may become a source of particulate, contaminating integrated circuits and structures formed on the substrate.

In order to maintain high manufacturing yield and low costs, the removal of contaminant and/or residual polymer from the substrate becomes increasingly important. Residual polymer present on the substrate bevel may be dislodged and adhered to the frontside of the substrate, potentially damaging integrated circuits formed on the frontside of the substrate. When residual polymer present on the substrate bevel is dislodged and adhered to a backside of a substrate, non-planarity of the substrate during a lithographic exposure process may occur and result in lithographic depth of focus errors. Additionally, residual polymer may also result in voids or open circuits if particles fall in vias or trenches during etch. Furthermore, residual polymer present on the backside of the substrate may also be dislodged and flaked off during robot transfer processes, substrate transport processes, subsequent manufacturing processes, and so on, thereby resulting in contamination in transfer chambers, substrate cassettes, process chambers, and other processing equipment that may be subsequently utilized in the circuit component manufacturing process. Contamination of processing equipment results in increased tool down time, thereby adversely increasing the overall manufacturing cost.

In conventional polymer removal processes, a scrubber clean is often utilized to remove polymers from a substrate bevel and backside. However, during the cleaning process, structures formed on the frontside of the substrate may also be damaged, resulting in product yield loss and device failure.

During etching, a photoresist layer is typically utilized as an etch mask layer that assists transferring features to the substrate. However, incomplete removal of the photoresist layer on the frontside of the substrate may also contaminant the structures formed on the substrate, resulting in product yield loss and device failure.

Therefore, there is a need for an apparatus and method to remove polymer from substrate backside or substrate frontside while maintaining integrity of structures formed on substrate frontside.

### SUMMARY OF THE INVENTION

Embodiments of the present invention generally provide a method of cleaning a substrate such as by removing polymer from a substrate edge. In one embodiment, the method includes providing a cleaning gas comprising H₂ and N₂ or H₂ and H₂O, initiating a plasma from the cleaning gas, and removing polymer that formed on at least one of a frontside, a bevel edge, and a backside of the substrate with the plasma.

In another embodiment, the method includes providing an oxygen free cleaning gas comprising H₂ and N₂, initiating a plasma from the cleaning gas, and removing polymer that formed on at least one of a frontside, a bevel edge, and a backside of the substrate with the plasma, the substrate having at least one contact hole formed thereon.

In yet another embodiment, the method includes providing a cleaning gas comprising at least one of H₂ and H₂O, initiating a plasma from the cleaning gas, and removing polymer that formed on at least one of a frontside, a bevel edge, and a backside of the substrate with the plasma, the substrate having a structure with low-k dielectric film.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a sectional schematic diagram of an exemplary polymer removal processing chamber.

FIG. 1B is a close up of a substrate edge.

FIG. 2 is a process diagram of one embodiment of the present invention.

FIG. 3 is a process diagram of a second embodiment of the present invention.

FIG. 4 is a process diagram of a third embodiment of the present invention.

FIG. 5 is a cross-section of a contact hole in a semiconductor device.

FIG. 6 is a cross-section of an intermetal connect layer in a semiconductor device.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

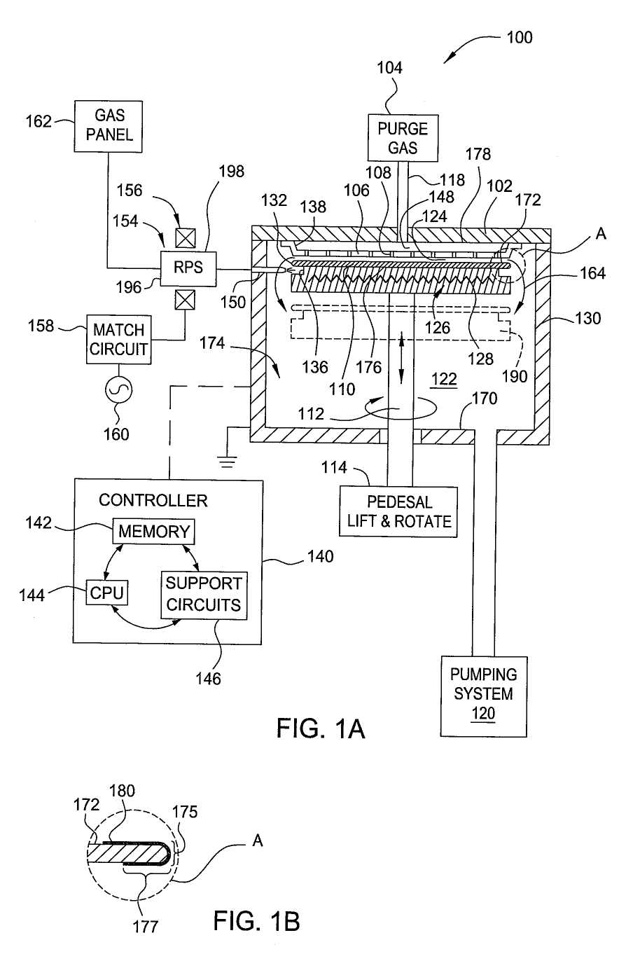

Embodiments of the present invention include methods of cleaning a substrate by removing polymers from a substrate bevel edge, frontside region, or backside of the substrate. The substrate bevel, backside and frontside region may be efficiently cleaned. In one embodiment where a photoresist layer is present on the frontside of the substrate, the photoresist layer may be removed as well. The embodiments are generally used to remove polymers from a substrate generated during a semiconductor substrate process, such as an etching or deposition process, among others. One exemplary polymer removal apparatus which may use the methods of the present invention described herein, with reference to FIG. 1A, is a polymer removal reactor available from Applied Materials, Inc. of Santa Clara, Calif. It is contemplated that embodiments described herein may be performed in other reactors, including those available from other manufacturers.

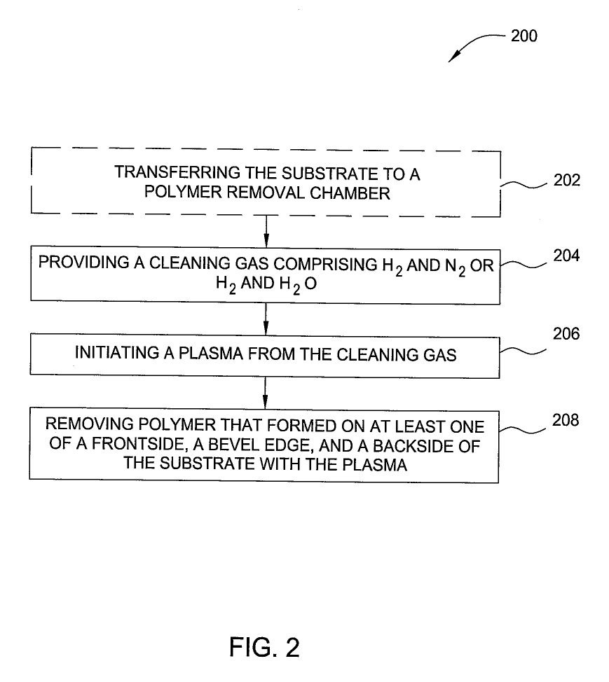

FIG. 1A depicts a sectional schematic diagram of an exemplary peripheral polymer removal processing chamber 100 having a plasma source 154 utilized to remove polymer 180 from the edge of a substrate 110 including the frontside 172, bevel 175, and backside 177 as show in FIG. 1B. A controller 140 including a central processing unit (CPU) 144, a memory 142, and support circuits 146, is coupled to the processing chamber 100. The controller 140 controls components of the processing chamber 100, processes performed in the processing chamber 100, as well as may facilitate an optional data exchange with databases of an integrated circuit fab. The controller 140 may be programmed to run embodiments of the invention such as those depicted in FIGS. 2-4, which are discussed in greater detail below.

The processing chamber 100 includes a chamber lid 102, a bottom 170 and side walls 130 that enclose an interior volume 174. The chamber lid 102 has a bottom surface defining a ceiling 178 of the processing chamber 100. In the depicted embodiment, the chamber lid 102 is a substantially flat member. Other embodiments of the processing chamber 100 may have other types of lids, e.g., a dome-shaped ceiling and/or metallic construction.

A substrate support assembly 126 is disposed in the processing chamber 100 dividing the interior volume 174 into an upper zone 124 and a lower zone 122. The substrate support assembly 126 has an upper surface 176 utilized to receive a substrate 110 disposed thereon. In one embodiment, the substrate support assembly 126 has a step 136 formed in an upper periphery region of the substrate support assembly 126. The step 136 has a width selected to reduce a diameter of the upper surface 176 of the substrate support assembly 126. The diameter of the upper surface 176 of the substrate support assembly 126 is selected so that an edge 132 of the substrate 110 is exposed when the substrate is disposed on the substrate support assembly 126. Substrate edge 132 is shown in greater detail in FIG. 1B, which is a magnified cross-section of FIG. 1A. A polymer 180 may deposit on the substrate edge 132 including a frontside 172, bevel edge 175, and a backside 177 of the substrate 110, as shown in FIG. 1B.

In FIG. 1A, a heating element 128 is within the substrate support assembly 126 to facilitate temperature control of the substrate 110 disposed on the substrate support assembly 126. A rotatable shaft 112 extends upward through the bottom 170 of the processing chamber 100 and is coupled to the substrate support assembly 126. A lift and rotation mechanism 114 is coupled to the shaft 112 to control rotation and elevation of the substrate support assembly 126 relative to the chamber ceiling 178. A pumping system 120 is coupled to the processing chamber 100 to facilitate evacuation and maintenance of process pressure.

A purge gas source 104 is coupled to the chamber lid 102 through a gas supply conduit 118. The purge gas source 104 supplies purge gas to the processing chamber 100. A gas distribution plate 106 is coupled to the chamber ceiling 178 and has a plurality of apertures 108 formed therein. An internal plenum 148 is defined between the gas distribution plate 106 and the chamber ceiling 178 that facilitates communication of purge gases supplied from the purge gas source 104 to the plurality of apertures 108. The purge gases exit the apertures 108 and travel through the upper zone 124 of the processing chamber 100 so as to blanket a frontside 172 of the substrate 110. In one embodiment, the purge gas is selected to be non-reactive to the materials disposed on the frontside 172 of the substrate. In other embodiments, a purge gas source may be unnecessary.

A remote plasma source 154 is coupled to a gas outlet port 150 formed through a sidewall 130 of the processing chamber. In the embodiment depicted in FIG. 1A, the remote plasma source 154 is remotely coupled to the processing chamber 100. The gas outlet port 150 may include a nozzle extending into the interior volume 174 to precisely direct the gas flow exiting the nozzle.

The remote plasma source 154 includes a remote plasma chamber 198 having an internal volume 196 coupling a gas panel 162 to the gas outlet port 150. One or more inductive coil elements 156 disposed adjacent to the remote plasma chamber 198 are coupled, through a matching network 158, to a radio frequency (RF) plasma power source 160 to generate and/or maintain plasma in the volume 196 formed from gases provided by the gas panel 162. The gas panel 162 provides reactive gases to the remote plasma source 154. In one embodiment, the gas panel 162 provides H₂ and N₂. In another embodiment, the gas panel 162 provides H₂ and H₂O. In still another embodiment, the gas panel 162 provides at least one of O₂, NH₃, or CO₂ in combination with any of H₂, N₂ and H₂O, though O₂ may not be preferred in some embodiments because exposure to oxygen may damage features formed in layers on the frontside 172 of the substrate 110. The gases supplied to the remote plasma chamber 198 are dissociated as neutrals and radicals by plasma generated in the internal volume 196. The dissociated neutrals and radicals are further directed through the gas outlet port 150 to the processing chamber 100.

The elevation of substrate support assembly 126 may be selected to position the gas outlet port 150 above, below or aligned with the substrate edge 132 to selectively clean the top frontside 172, bevel edge 175, and/or backside 177 of the substrate 110. Outflow of the dissociated neutral and radicals from the gas outlet port 150 may be directed toward the step 136, as the substrate is rotated, thereby filling a cavity defined between the substrate backside 177 and the substrate support assembly 126. The cavity assists retaining gases so that the substrate frontside 172, substrate bevel 175, and the substrate backside 177 are exposed to the reactive gases for a longer period of time, thereby improving the polymer removal efficiency. Optionally, the substrate support assembly 126 may be positioned in a lower position (shown in phantom) so that the gas outflow from the gas outlet port 150 may be directed to an exposed edge on frontside 172 of the substrate 110, thereby assisting polymer removal, or remaining photoresist layer, if any, from the frontside 172 of the substrate 110.

In operation, the purge gas from the purge gas source 104 as well as the reacting gas from the plasma source 154 may be simultaneously supplied to both the frontside 172, periphery region of the substrate 110 to remove polymer 180, and/or remaining photoresist layer, if any, from the substrate 110. Alternatively, the gases from the purge source 104 and/or plasma source 154 may be pulsed into the processing chamber 100. During processing, the substrate support assembly 126 may be moved in a vertical direction, rotated, or orientated to position the substrate 110 between the upper zone 124 and lower zone 122 so that gases are delivered from the gas outlet port 150 to a desired region of the substrate 110. The rotation of the substrate 110 assists gases from the plasma source 154 to be applied uniformly to the substrate edge 132 or other desired region of the substrate 110.

Various material layers may be present on the substrate 110 during semiconductor processing, including a low-k layer, a barrier layer, a silicon containing layer, a metal layer, and a dielectric layer. Examples of material layers to be etched includes silicon carbide oxide (SiOC), such as BLACK DIAMOND® film commercially available from Applied Materials, Inc., silicon carbide (SiC) or silicon carbide nitride (SiCN), such as BLOk® film commercially available from Applied Materials, Inc., CVD oxide, SiO₂, polysilicon, TEOS, amorphous silicon, USG, silicon nitride (SiN), boron doped or phosphorous doped silicon film, and the like.

During processing of the various material layers on the frontside 172 of substrate 110, polymer 180 may form on the edge 132 of the substrate 110. For exemplary purposes, an etching process that may cause polymer 180 to form on the edge 132 of the substrate 110 will be described. Although the process described here is an etching process, it is contemplated that the substrate 110 may be processed under different applications, such as deposition, thermal anneal, implant and the like.

During an etching process, the etched materials may combine with the components of the etchant chemistry, as well as with the components of the mask layers, if any, and by-products of the etch process, thereby forming polymer residues. The etch by-products and polymer residues 180 may deposit on the edge 132 of substrate 110, including frontside 172, bevel 175, and backside 177 of the substrate 110. Furthermore, portions of the photoresist layer utilized during the etching process may not be entirely consumed or removed from the substrate frontside 172 after the etching process. The photoresist layer remaining on the substrate frontside 172 may result in organic or polymer contamination on the substrate frontside 172 if not removed by the subsequent strip or ash process, thereby adversely affecting the performance of devices formed on the substrate 110.

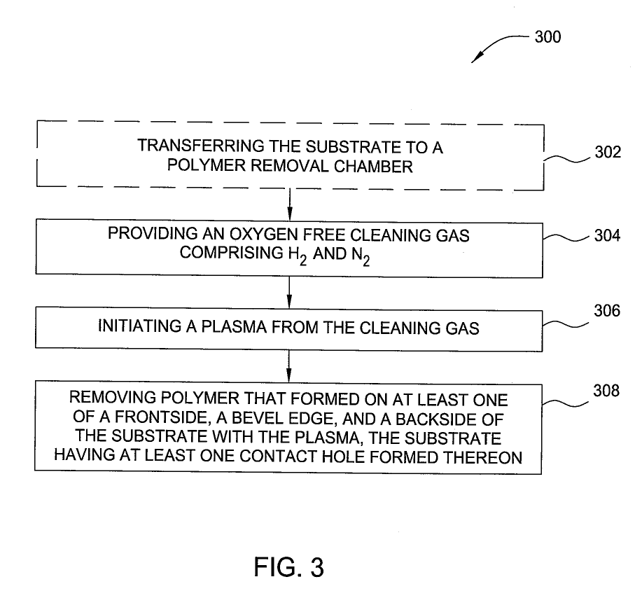

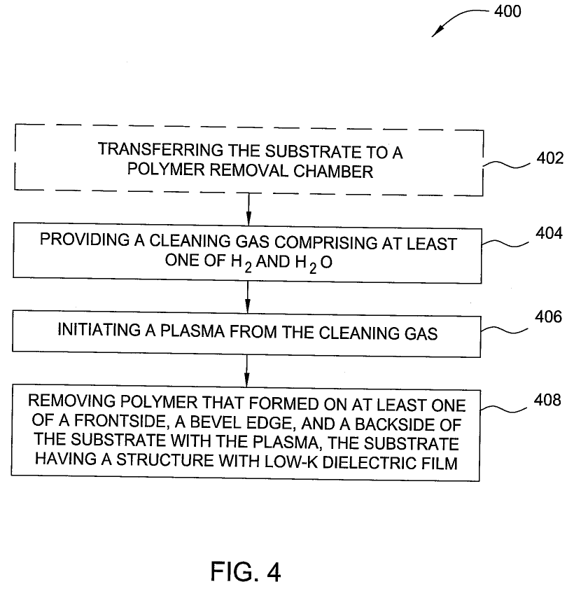

FIG. 2 depicts a flow diagram of one embodiment of a method 200 for cleaning a substrate e.g. removing polymer and/or other residue from the substrate. The method 200 may be practiced in the chamber 100 or other suitable tool. It is contemplated that the method 200 may be performed in other suitable processing systems, including those from other manufacturers, or in facilities wherein the polymer removal chamber and etch reactor are on separate tools. Other embodiments, such as those depicted in FIGS. 3 and 4, may also be performed in suitable processing systems, including those from other manufacturers, or in facilities wherein the polymer removal chamber and etch reactor are on separate tools.

The method 200 may begin at box 202, where a substrate may be transferred to a polymer removal chamber, such as a peripheral polymer removal chamber, the dashed box outline indicating that box 204 is optional in the cleaning process, as other suitable chambers for cleaning the substrate may be used. A dashed box outline in any of FIGS. 2-4 indicates that the box is optional. The substrate 110 may be any substrate or material surface upon which film processing is performed. In one embodiment, the substrate 110 may have a material layer or material layers formed thereon utilized to form a structure. The material layers that may be disposed on the substrate may include a dielectric layer, such as a SiOC, SiO₂ or a SiCN, SiC or SiN layer. The substrate 110 may alternatively utilize a photoresist layer as an etch mask to promote the transfer of the features or structures to the substrate 110. In another embodiment, the substrate may have multiple layers, e.g., a film stack, utilized to form different patterns and/or features, such as dual damascene structures and the like. The substrate 110 may be a material such as crystalline silicon (e.g., Si<100> or Si<111>), silicon oxide, strained silicon, silicon germanium, doped or undoped polysilicon, doped or undoped silicon wafers and patterned or non-patterned wafers silicon on insulator (SOI), carbon doped silicon oxides, silicon nitride, doped silicon, germanium, gallium arsenide, glass, sapphire, metal layers disposed on silicon and the like. The substrate may have various dimensions, such as 200 mm or 300 mm diameter wafers, as well as, rectangular or square panels.

At box 204, a cleaning gas comprising H₂ and N₂ or H₂ and H₂O is provided to the processing chamber, and at box 206, a plasma is initiated from the cleaning gas previously provided. In one embodiment, the plasma is a remote plasma, such as that shown in FIG. 1A. However, other embodiments include initiating the plasma within the processing chamber. At box 208, polymer that formed on at least one of a frontside, a bevel edge, and a backside of the substrate is removed with the plasma. Preferably, the entire polymer formed on the bevel edge, backside, and substrate frontside is removed. Typically, the polymer formed on the substrate results from previous substrate etching processes.

The cleaning gas of method 200 may also further include at least one of O₂, NH₃, or CO₂. Alternatively, the cleaning gas may include only H₂ and N₂ or, in another embodiment, H₂ and H₂O. The cleaning gas may be at most 5% H₂O. In another embodiment, the cleaning gas may be at most 30% of H₂. A carrier gas may also be used as part of the cleaning gas such as N₂.

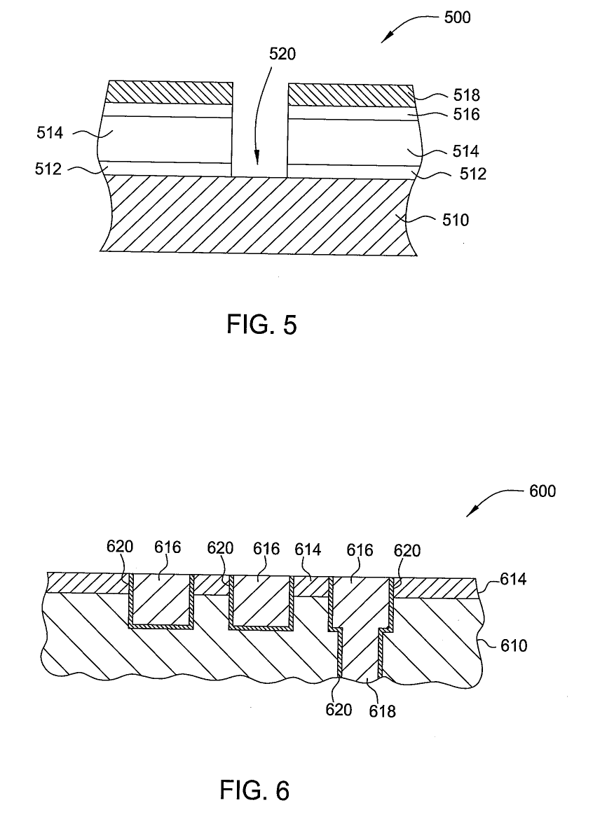

Referring now to FIG. 3, another embodiment of a method 300 for cleaning a substrate is depicted. The method 300 may be practiced in the chamber 100 or other suitable tool. The method 300 may begin at box 302 where a substrate may be transferred to a polymer removal chamber for removing polymer 180 on substrate 110 as depicted in FIGS. 1A and 1B. In this embodiment, the substrate 110 has a contact hole formed thereon as further depicted in FIG. 5.

At box 304, an oxygen free cleaning gas comprising H₂ and N₂ is provided. Once the oxygen free cleaning gas has been provided, a plasma is initiated from the cleaning gas at box 306. The plasma is than used to remove polymer that formed on at least one of a frontside, bevel edge, and a backside of the substrate with the plasma at box 308. In this embodiment, the substrate has at least one contact hole formed thereon. A nickel silicide layer on the bottom of the contact hole may be exposed to the oxygen free cleaning gases during polymer removal. However, by using the oxygen free cleaning gas comprising H₂ and N₂, it is believed that the nickel silicide layer on the bottom of the contact hole remains undamaged during the cleaning process while removing any extraneous substrate polymer or other residue.

Method 300 may be used to clean a substrate after forming a structural layer 500 as depicted in FIG. 5. A photoresist layer 518 is deposited on top of a capping layer 516, a dielectric layer 514, a barrier layer 512, a metal layer 510, and a substrate (not shown). The photoresist layer 518 is processed according to known methods such as photolithography and etching, to form contact hole 520. This aspect of the invention is found in boxes 302 and 304 of FIG. 3. After etching the contact hole 520, the metal layer 510, such as a nickel silicide layer, on the bottom of the contact hole 520 is exposed. Often during formation of structure 500, extraneous polymer or other etching residue may form on the edge of a substrate necessitating a cleaning process to remove the undesired and potentially contaminating polymer and residue from the substrate frontside, bevel edge, and backside. It is believed that processing the substrate having structure 500 according to boxes 304, 306, and 308 of method 300 depicted in FIG. 3 will clean the substrate and remove the extraneous polymer and other processing residue better than other known methods and without damaging previously formed structures on the substrate.

Referring now to FIGS. 4 and 6, another embodiment of a method 400 for cleaning a substrate is depicted. The method 400 may be practiced in the chamber 100 or other suitable tool. The method 400 may begin at box 402 where a substrate may be transferred to a polymer removal chamber for removing polymer 180 on substrate 110 as depicted in FIGS. 1A and 1B. In this embodiment, the substrate has a structure with low-k dielectric film such as an intermetal low-k dielectric layer. Such an intermetal low-k dielectric layer 610 is shown in FIG. 6. The intermetal low-k dielectric layer below the polymer layer may be etched, often resulting in polymer being deposited on the substrate frontside, bevel edge, and backside. A cleaning gas comprising at least one of H₂ and H₂O is provided at box 404. In one embodiment, the cleaning gas may include only H₂ and H₂O. In another embodiment the cleaning gas may comprise at least one of O₂, NH₃, or CO₂. In one embodiment, the cleaning gas is at most 10% H₂O.

Once the cleaning gas has been provided, a plasma is initiated from the cleaning gas at box 406. In one embodiment, the plasma is a remote plasma. The plasma is than used to remove polymer that formed on at least one of a frontside, bevel edge, and backside of the substrate with the plasma at box 408. The intermetal low-k dielectric layer may be exposed to the cleaning gases during polymer removal. However, by using the cleaning gas chemistries described above in method 400, it is believed that the intermetal low-k dielectric layer on the substrate remains undamaged during the cleaning process.

Method 400 may be used to clean a substrate after forming an intermetal dielectric structure 600 as depicted in FIG. 6. A photoresist layer (not shown) is deposited (usually a spin-on process) on top of a dielectric layer 610 used to form various structures in the dual damascene intermetal layer as shown. For example conducting lines 616 and via plug 618 may be formed in the intermetal low-k dielectric layer 610 by etching the dielectric layer 610 according to known methods which use photolithography methods and the photoresist to pattern the mask to eventually form conducting lines 616 and via plug 618. Other structural elements may also be formed in the intermetal dielectric structure 610, such as a capping layer 614 and liner layers 620.

Often during formation of intermetal dielectric structure 600, extraneous polymer or other etching residue may form on the edge of a substrate necessitating a cleaning process to remove the undesired and potentially contaminating polymer and residue from the substrate frontside, bevel edge, and backside. It is believed that processing the substrate having structure 600 according to boxes 404, 406, and 408 of method 400 depicted in FIG. 4 will clean the substrate and remove the extraneous polymer and other processing residue better than other known methods and without damaging previously formed structures on the substrate.

In any of the embodiments of the invention, the processed (e.g., etched) substrate may be transferred to a polymer removal processing chamber 100 to remove the polymer residuals, photoresist layer, if any, and etch by-products from the substrate 110 generated during previous processing techniques such as etching. The remote plasma source of the processing chamber 100 supplied active reactant, such as hydrogen nitrogen containing gases or hydrogen and water vapor containing gases, to the processing chamber 100 to assist removal of polymer residuals, photoresist layer and etch by-products from the substrate 110. As the plasma produced radicals are highly reactive radicals to polymers, upon supplying reactive species of the cleaning gas into the processing chamber 100, the species react with the polymers, forming volatile compounds, which are readily pumped and gassed out of the processing chamber 100.

In one embodiment, the reactive species supplied to the processing chamber 100 is generated from the remote plasma source from a gas mixture including H₂ and water vapor (H₂O). Alternatively, various gas mixture combinations of hydrogen (H₂), oxygen (O₂), nitrogen (N₂), carbon dioxide (CO₂), and ammonia (NH₃) may be supplied to the remote plasma source to generate the reactive species. For example, in the embodiment where the intermetal dielectric layer on the substrate is etched, such as a silicon oxycarbide layer (SiOC), the reactive species supplied from the remote plasma source to the processing chamber includes H₂O and H₂. Alternatively, if a higher polymer removal rate is desired and dielectric layer damage is acceptable, an O₂ and N₂ based cleaning gas may be supplied to the remote plasma source. If the process requires a high polymer removal rate with an acceptable minimal ultra low-k dielectric damage and metal oxidation, the reactive species supplied from the remote source to the processing chamber may include H₂ and CO₂. In another embodiment where a contact hole or via is etched in a layer below the polymer, such as in a silicon oxide film layer (SiO₂), and a layer of silicide in the contact hole or via, such as nickel silicide, is exposed, the reactive species supplied from the remote plasma source to the processing chamber includes H₂ and N₂.

As discussed above, as the substrate support assembly 126 may be moved and rotated, in the embodiments wherein a photoresist material is present on the substrate frontside 172, the photoresist material may be removed along with polymer residues, e.g., the photoresist material is stripped during the polymer removal process.

In the embodiment where the material etched on the substrate is a silicon oxycarbide film (SiOC), the gas mixture supplied through the remote plasma source to remove substrate frontside, bevel, and backside polymer includes H₂ and H₂O. H₂ gas is supplied at a flow rate between about 1000 sccm and about 4000 sccm, such as about 2000 sccm. H₂O is supplied at a flow rate between about 10 sccm and about 100 sccm, such as about 30 sccm. The remote plasma source may provide a plasma power at about 4500 Watts. An inert gas, such as Argon may be used to strike the plasma. The pressure controlled for processing is between about 1 Torr and about 5 Torr, such as about 2 Torr. A purge gas may be used such as N₂, Ar, H₂, and He.

After substrate frontside, bevel, and backside polymer have been removed, the substrate support assembly 126 may be dropped to the lower position readily to receive the reactive species from the remote plasma source to substrate frontside 172 to remove photoresist layer. During photoresist or frontside polymer removal process, the gas mixture supplied through the remote plasma source includes H₂ and H₂O. H₂ gas is supplied at a flow rate between about 1000 sccm and about 4000 sccm, such as about 2000 sccm. H₂O is supplied at a flow rate between about 10 sccm and about 100 sccm, such as about 30 sccm. The remote plasma source may provide a plasma power at about 4500 Watts. An inert gas, such as Argon may be used to strike the plasma. The pressure controlled for processing is between about 1 Torr and about 5 Torr, such as about 2 Torr. A purge gas may be used such as H₂, and He. During frontside polymer removal, the pedestal height would be lower relative to the nozzle position.

In the embodiment where a contact hole or via is etched in a layer below the photoresist, such as in a silicon oxide film layer (SiO₂), and a silicide layer in the hole or via is exposed, the gas mixture supplied through the remote plasma source to remove substrate frontside, bevel, and backside polymer includes H₂ and N₂. H₂ gas is supplied at a flow rate between about 5 sccm and about 500 sccm, such as between about 50 sccm. N₂ is supplied at a flow rate between about 100 sccm and about 4000 sccm, such as between about 1500 sccm. The pressure controlled for processing is between about 1 Torr and about 5 Torr, such as about 1.5 Torr.

Thus, the present invention provides methods for cleaning substrates by removing polymer residues formed on the frontside, bevel edge, or backside of a substrate. Efficient removal of polymer residuals not only eliminates contamination on a substrate but also prevents transfer of contamination into other processing chambers during subsequent processing, thereby improving product yield and enhancing productivity and process throughput. Moreover, the methods provide a process for removing the polymer residuals without damaging various layers and formations on the frontside of the substrate.

While the foregoing is directed to embodiments of the present invention, other and further embodiments of the invention may be devised without departing from the basic scope thereof, and the scope thereof is determined by the claims that follow.

What is claimed is:

1. A method of cleaning a substrate, comprising:
providing a cleaning gas comprising H₂ and N₂ or H₂ and H₂O;
initiating a plasma from the cleaning gas; and
removing polymer that formed on at least one of a frontside, a bevel edge, and a backside of the substrate with the plasma.

2. The method of claim 1, wherein the cleaning gas further comprises at least one of O₂, NH₃, or CO₂.

3. The method of claim 1, wherein the cleaning gas consists of H₂ and N₂ or H₂ and H₂O.

4. The method of claim 1, further comprising transferring the substrate to a polymer removal chamber.

5. The method of claim 1, wherein the cleaning gas is at most 5% H₂O.

6. The method of claim 1, wherein the cleaning gas is at most 30% H₂.

7. The method of claim 1, wherein the plasma is a remote plasma.

8. A method of cleaning a substrate, comprising:
providing an oxygen free cleaning gas comprising H₂ and N₂;
initiating a plasma from the cleaning gas; and
removing polymer that formed on at least one of a frontside, a bevel edge, and a backside of the substrate with the plasma, the substrate having at least one contact hole formed thereon.

9. The method of claim 8, wherein a nickel silicide layer on the bottom of the contact hole is exposed.

10. The method of claim 1, wherein the cleaning gas consists of H₂ and N₂.

11. The method of claim 8, wherein the cleaning gas is at most 30% of H₂.

12. The method of claim 8, further comprising transferring the substrate to a polymer removal chamber.

13. The method of claim 8, wherein the plasma is a remote plasma.

14. A method of cleaning a substrate, comprising:
providing a cleaning gas comprising at least one of H₂ and H₂O;
initiating a plasma from the cleaning gas; and
removing polymer that formed on at least one of a frontside, a bevel edge, and a backside of the substrate with the plasma, the substrate having a structure with low-k dielectric film.

15. The method of claim 14, wherein the cleaning gas consists of H₂ and H₂O.

16. The method of claim 14, further comprising transferring the substrate to a polymer removal chamber.

17. The method of claim 14, wherein the cleaning gas further comprises at least one of O₂, NH₃, or CO₂.

18. The method of claim 14, wherein the cleaning gas is at most 10% H₂O.

19. The method of claim 14, wherein the plasma is a remote plasma.
